(19) United States
(12) Patent Application Publication
(10) Pub. No.: US 2018/0306321 A1
(43) Pub. Date: Oct. 25, 2018

(54) MAGNETIC SEAL FOR CRYOGENIC MACHINES

(71) Applicant: L'Air Liquide, Societe Anoyme pour I'Etude et I'Exploitation des Procedes Georges Claude, Paris (FR)

(72) Inventors: Didier PATHIER, Voisins Le Bretonneux (FR); Christian REYMOND, Montmorency (FR); Joachim SCHWARZINGER, Klosterneuburg (AT); Jo ALGOET, Wijtschate-Heuvelland (BE); Caroline MOZIAR, Geulph, Ontario (CA)

(73) Assignee: L'Air Liquide, Societe Anoyme pour I'Etude et I'Exploitation des Procedes Georges Claude, Paris (FR)

(21) Appl. No.: 15/767,535

(22) PCT Filed: Sep. 22, 2016
(86) PCT No.: PCT/FR2016/052402

§ 371 Date: Apr. 11, 2018

(30) Foreign Application Priority Data
Oct. 13, 2015 (FR) 1559725

(51) Int. Cl. F16J 15/02; F25D 19/00

(52) U.S. Cl. CPC F16J 15/027; F25D 19/006

(57) ABSTRACT

A sealing system suitable for equipping a cryogenic apparatus used for transforming or storing food, medical or biological products, characterized in that:—the sealing system comprises a first part, made from a soft and resilient material, constituting a shape, suitable for being pressed between two elements of the apparatus to form a seal;—said first part comprises, within the structure of same, one or more magnetic metal plates;—the sealing system further comprises a second part, constituted by one or more magnets, capable of being positioned in the structure of the machine, at the location or locations that need to support a seal, said magnets preferably being spaced at regular intervals.

### CROSS-REFERENCE TO RELATED APPLICATION

This application is a § 371 of International PCT Application PCT/FR2016/052402, filed Sep. 22, 2016, which claims § 119(a) foreign priority to French patent application FR 1 559 725, filed Oct. 13, 2015.

### BACKGROUND

### Field of the Invention

The present invention relates to the field of cryogenic apparatus used to transform or store food, medical or biological products, such as tunnels, cabinets, etc.

Interest is therefore focused here on the equipment which comprise one or more doors such as hinged or sliding doors, and the examples that can be cited here include deepfreezing cabinets, cryotherapy cabinets, storage cabinets or tanks for medical or biological products of cell, blood or embryo type, but also the linear deep freezers provided with doors (tunnels with belts and doors), immersion baths with doors, vibrating cryogenic systems with doors, or even drum cryogenic systems with doors.

However interest is also focused on the machines which are provided with a system of covers that can be raised or tilted manually or mechanically such as belt tunnels, drums and specific cryogenic deep freezing equipment with covers that can be raised electrically, pneumatically, hydraulically, or by hand with a mechanical system.

### Related Art

In this field, one problem well known to the users and those responsible for servicing such machines is linked to the seals with which these machines are equipped, seals which to have to withstand extreme temperatures and are thus subjected to rough testing. Their life is often limited and maintenance is not easy to perform. Furthermore, the seal fixing zone is often a retention zone that lends itself to bacterial development.

The most widely used existing seals are made of silicone and have a P shape. The silicone material withstands the wide temperature variations fairly well, it remains fairly flexible at low temperatures. However, despite the good properties of silicone, this seal is not indestructible and it wears out with time, so it has to be replaced periodically.

Moreover, the P shape allows for simple fixing by pinching of the lip using screws. This system is simple but it does not observe the rules of hygienic design for equipment intended for the food industries, it cannot be dismantled during the cleaning of the equipment and the pinched zone is never cleaned and is a potential source of microbial contamination.

Maintenance of this type of seal is generally fairly lengthy but fairly simple except for the zones with limited access where the maintenance is particularly complex and lengthy.

To sum up, the existing seals therefore exhibit essentially two drawbacks:

Being subjected to strong temperature variations (typically +20 to −100° C.), the wear of the seals is rapid and the maintenance thereof is complex and takes a long time.

The seal fixing system has numerous bacterial retention zones and remains difficult to clean.

It is therefore understood that a technical solution offering a seal which would be fixed to the machine with a system that is hygienic and easy to clean would be very interesting for the users of such machines. Similarly, a seal whose replacement could be performed easily and rapidly would be very interesting for the maintenance departments of the agro-food factories using such machines.

### SUMMARY OF THE INVENTION

As will be seen in more detail hereinbelow, the technical solution proposed by the present invention has the particular objective of making the cleaning of the seal possible every day, without complex operations, and to make the maintenance easy even in the zones with difficult access such as the zones under the doors. On the other hand, this solution does not aim to reduce the maintenance operations by increasing the life of the seal.

According to the invention, the seal comprises a first part, produced in a soft and resilient material, forming a shape, said shape being capable of being pressed between two elements of the apparatus to form a seal.

This first part comprises, in its structure (or on a surface of its structure), one or more plates made of magnetic metal.

The seal system further comprises a second part, composed of one or more magnets, capable of being positioned in the structure of the machine, at the point or points that have to support a seal (and that have to face the “shape” described above), said magnets being preferentially spaced at regular intervals.

And, to better visualize the invention, a preferred implementation of the invention is explained hereinbelow in which the “shape” described above is that of a tube:

The seal comprises a first part composed of a soft and resilient material, withstanding very low temperatures without becoming rigid, for example of “Knitmesh™” type, a material formed by a set of braided or “knitted” thin and resilient stainless steel meshes. This material is advantageous for forming the part which has to remain flexible and resilient in the seal, whatever the temperature. This material of knitted metal threads is preferred according to the invention but it is also possible to envisage other solutions and in particular the use of silicone or any other soft and resilient material, or even a seal-tight tube filled with air or gas, or even a knitting of plastic threads.

As an example of implementation, one of the materials described above is then captive in a tube (of any section) produced in a way that is tight to the ingress of water, said tube being produced for example in plastic material, which remains flexible at low temperatures even if it may lose resilience. However, the soft material concerned “such as Knitmesh™” remains resilient and makes it possible to compensate for the defect that the outer tube may exhibit.

Into this tube there are inserted one or more plates made of magnetic metal, a metal which is attracted by a magnet.

As indicated above, in the structure of the machine concerned (cabinet, tunnel, etc.), typically at the points which have to support a seal, there are then inserted one or more magnets, preferentially spaced at regular intervals.

When the machine is ready to operate, the user can then position the seal on the machine, the latter will naturally be attracted by the magnet or magnets and be positioned at the desired point.

Thus, the seal is fixed to the machine with no visible support so there are no support pieces that are difficult to clean.

When the machine is to be cleaned, the seal can be easily removed (by pulling upward without tools). The support of the machine is then smooth and seal-free. It can be cleaned very easily and there is no retention zone to make this washing difficult. The seal, for its part, can also be easily cleaned with no retention zone.

When it is time to resume production, the seal is easily replaced and held by the magnets as explained above.

For all these reasons, in terms of maintenance, the dismantling of a damaged seal and the replacement thereof with a new seal takes only a few seconds.

The present invention then relates to a seal system, capable of equipping a cryogenic apparatus used to transform or store food, medical or biological products, characterized as follows:

the seal system comprises a first part, produced in a soft and resilient material, forming a shape, capable of being pressed between two elements of the apparatus to form a seal;

said first part comprises, in its structure, one or more plates made of magnetic metal;

the seal system further comprises a second part, composed of one or more magnets, capable of being positioned in the structure of the machine, at the point or points that have to support a seal, said magnets being preferentially spaced at regular intervals.

It is understood from reading the above that this new seal system is simple and inexpensive, and makes it possible to render the seals of the cryogenic machines concerned hygienic and very easy to service.

### BRIEF DESCRIPTION OF THE FIGURES

FIG. 1 illustrates the structure of a prior art seal.

FIG. 2 illustrates an embodiment of the seal of the invention.

FIG. 3 illustrates a variation of the embodiment of FIG. 2.

FIG. 4 illustrates a variation of the embodiment of FIG. 3.

FIG. 5 illustrates another embodiment of the seal of the invention.

### DETAILED DESCRIPTION OF THE INVENTION

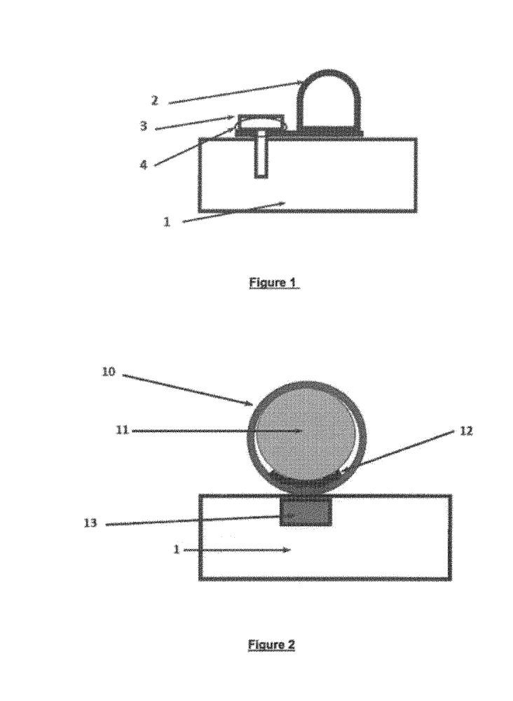

The attached FIG. 1 illustrates the structure of a “P”-shaped silicone seal with which such machines are currently commonly equipped.

The following elements are recognized in this figure:

the frame 1 of the machine (for example a cabinet);

the “P”-shaped seal 2;

this seal is traditionally fixed, for example on the portion of frame with which a door would come into contact, by a screw 3;

and the bacterial retention zone 4, between seal and frame, and between screw and seal, is then clearly seen.

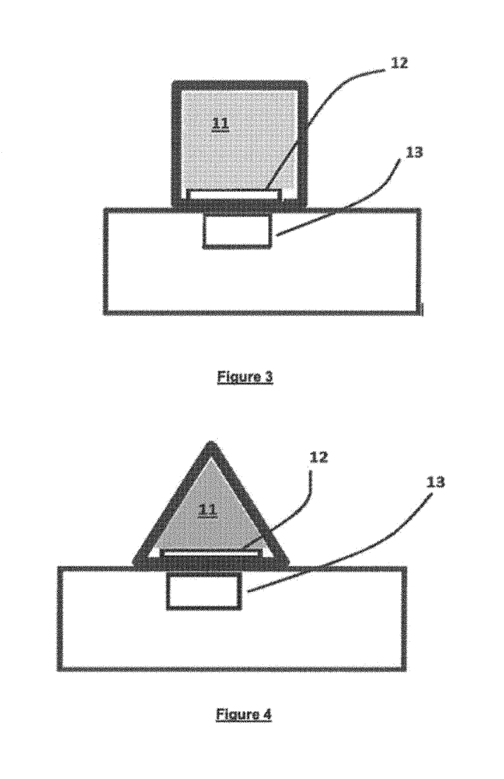

The attached FIG. 2 then illustrates an embodiment of a seal according to the invention, a seal in the form of a cylindrical tube, working in a way that is totally different from those of the prior art, a figure in which the following are recognized:

a portion of frame 1 of the machine that has to be equipped with a seal;

an endless tube (10), a tube that is here cylindrical, produced for example in plastic material, and in which is arranged a soft and resilient material (11), for example a material formed by a set of metal braids such as the Knitmesh™ material, said material not occupying all of the internal volume of the tube as seen in the figure;

the free internal volume then also comprises one or more plates (12) made of magnetic metal, preferentially positioned as in the figure at the external periphery of said internal volume;

to face it and allow the magnetic attraction between the two parts of the seal system, the seal system further comprises a second part, composed of one or more magnets (13), positioned in the structure of the machine, at the point or points that have to support a seal, said magnets being preferentially spaced at regular intervals (for example spaced at regular intervals in the depth of the figure along the tube 10).

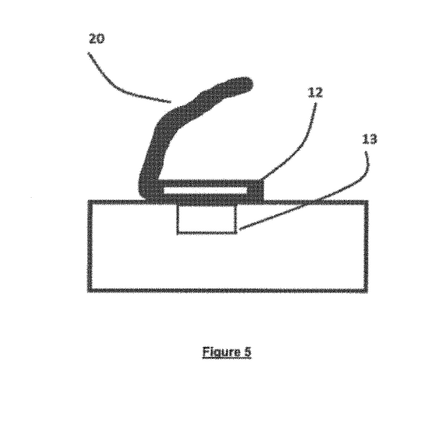

The attached FIGS. 3 and 4 illustrate variants of the embodiment presented in FIG. 2. And so, these figures illustrate in particular the fact that the seal can take different shapes, square or rectangle in the case of FIG. 3, triangle in the case of FIG. 4. These FIGS. 3 and 4 speak for themselves after having been well explained in FIG. 2, and will therefore not be described any further.

For its part, FIG. 5 presents another embodiment of the seal according to the invention, since the “shape” adopted here is not that of a tube, but that of a “lip” as will be seen.

In this case, the fixing principle remains the same, a metal part internal to the first part of the seal is magnetized by magnets present in the structure of the machine. It is still this effect of magnetization which is used to fix the seal onto its support. On the other hand, here, the seal is composed of a lip of which a part is secured to the metal element of the machine that has to have a seal, while the other is flexible and forms a seal when the door is closed, said lip being preferentially created in a resilient plastic material.

In this case, a tube is not therefore used to contain a soft and resilient material, it is the resilient material forming the lip which produces the seal. This material, as has been stated, can be plastic (remaining resilient at low temperature), but it can also be composed of a sheet of stainless steel (remaining resilient at low temperature) or of a composite material (remaining resilient at low temperature).

As will become clearly apparent to the person skilled in the art, very many configurations of tubes and magnets are possible to address each machine configuration: a single metal plate, several metal plates, for example two plates on both sides of the soft material to be able to mount the seal in both directions, or even the placement of several small plates placed end-to-end within the tube, on one side or on both sides of the soft material, etc.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context dearly dictates otherwise.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1-4. (canceled)

5. A seal system for equipping a cryogenic apparatus used to transform or store food, medical or biological products, said seal system comprising:
a first part made of a soft and resilient material formed in a shape, the first part being adapted and configured to be pressed between two elements of the apparatus to form a seal therebetween, the first part comprising one or more plates made of magnetic metal disposed in a structure of the first part; and
a second part comprising one or more magnets each of which is adapted and configured to be positioned in the structure of the cryogenic apparatus, at a point or points that support the seal system.

6. The seal system of claim 5, wherein the second part comprising more than one magnet, said magnets being spaced at regular intervals with respect to each other.

7. The seal system of claim 5, wherein:
said first part is configured as a tube in which is arranged a soft and resilient material, said material not occupying all of the internal volume of the tube;
the one or more plates made of magnetic metal being disposed within a internal volume of the tube.

8. The seal system of claim 7, wherein the one or more plates are positioned at an outer periphery of the internal volume.

9. The seal system of claim 7, wherein the tube is made of a plastic material.

10. The seal system of claim 9, wherein a soft and resilient material is disposed within the tube.

11. The seal system of claim 10, wherein the soft and resilient material does not occupy all of an internal volume of the tube.

12. The seal system of claim 10, wherein the soft and resilient material is a set of braided metal or plastic threads.

13. The seal system of claim 10, wherein the soft and resilient material is a set of knitted metal or plastic threads.

14. The seal system of claim 5, wherein said shape is that of a “lip”, of which one portion is secured to an element of the cryogenic apparatus that has to have a seal and another portion of which is flexible and forms a seal when it is pressed between said two elements of the apparatus.

15. The seal system of claim 14, wherein said first part is made of a plastic material.

16. The seal system of claim 14, wherein said first part is made of a sheet of stainless steel.

17. The seal system of claim 14, wherein said first part is made of a composite material.
